(19) United States
(12) Patent Application Publication
(10) Pub. No.: US 2026/0210746 A1
(43) Pub. Date: Jul. 23, 2026

(54) TEST MODULE FOR SINGLE-USE CORIOLIS FLOW METER

(71) Applicant: Endress+Hauser Flowtec AG, Reinach (CH)

(72) Inventors: Benjamin Schwenter, Ettingen (CH); Marc Werner, Grenzach-Wyhlen (DE)

(21) Appl. No.: 19/136,514

(22) PCT Filed: Dec. 13, 2023
(86) PCT No.: PCT/EP2023/085596

§ 371 Date: Jun. 6, 2025

(30) Foreign Application Priority Data
Dec. 20, 2022 (DE) 10 2022 134 029.5

(51) Int. Cl. G01F 1/84

(52) U.S. Cl. CPC G01F 1/8422; G01F 1/8427; G01F 1/8477

(57) ABSTRACT

A test module for a base module of a vibronic measuring system includes: a carrier element operable to oscillate when excited with an excitation frequency made of metal and/or plastics material; and at least one test element mechanically connected to the carrier element for producing a magnetic field, wherein the at least one test element is a permanent magnet, wherein the test module is designed to be inserted into the base module and to be releasably mechanically connected thereto such that the test module is locked in the base module or is immovable and/or such that the first element is held within the base module at a predefined testing position.

The invention relates to a test module for a base module of a (modular) vibronic measuring system and/or for measuring-system electronics of the vibronic measuring system that are electrically connected to the base module, and to a test arrangement. The invention also relates to a method for starting up and/or checking/testing a (modular) vibronic measuring system by means of such a test module or such a test arrangement.

From WO 2019/017891 A or WO 2021121867 A as well as the (not pre-published) German patent applications DE 102021105397.8, DE 102020133614.4, DE 102020132685.8, DE 102020133851.1, DE 102020133566.0, DE 102020132986.5, DE 102020132686.6, DE 102020132685.8, DE 102020131452.3, DE 102020132223.2, DE 102020127356.8, DE 102020114519.5 or DE 102020112154.7, modular vibronic measuring systems are known, namely formed by means of a base module, a vibronic module mechanically connected to the base module as well as measuring-system electronics electrically connected to the base module and serving to detect at least one measured variable of a fluid measured substance flowing in a (measured substance) line, namely to determine measured values for one or more measured variables, for example a mass flow, a volume flow, a density and/or a viscosity, of the measured substance.

The base module of such a (modular) vibronic measuring system has a (protective) housing with at least one chamber at least partially encased by a housing wall and one or more electrical coils, for example cylindrical and/or designed as air coils, which are placed (at a distance from each other) within the chamber of the (protective) housing and are at least indirectly mechanically connected to the housing wall. Each of the coils is also electrically connected to the measuring-system electronics. The measuring-system electronics can be housed at least partially within the (protective) housing and/or at least partially outside the (protective) housing, for example in a separate electronics housing. In particular, the base module is also configured to receive the vibronic module of the measuring system and to be mechanically firmly connected thereto (forming a vibration-type measuring transducer), but nevertheless detachably connected thereto, in particular to form a measuring sensor of the vibration type or the vibronic measuring system itself; this is also done in particular in such a manner that the vibronic module is locked in the base module or cannot be moved. The vibronic module of the respective measuring system is also designed to be replaceable, in such a manner that it can be inserted into the chamber, in particular also on site, from outside the (protective) housing of the base module or through an (insertion) opening of the housing provided in the housing wall, and that it can be removed from the base module again in a non-destructive manner, possibly also without tools, in particular namely from outside the housing and/or can be removed through the (slide-in) opening of the housing or without the base module itself having to be handled or removed from the (process) plant. This also makes it possible, among other things, to retrofit a vibronic module subsequently on site, i.e., into an already installed base module, or to replace a defective or worn vibronic module on site with an intact new, vibronic module, which may only be used once or only for a specified period of time (“disposable”).

The vibronic module furthermore has one or more, for example cylindrical, permanent magnets and is furthermore configured to be installed in the base module in such a manner that each of the permanent magnets is placed within the aforementioned chamber, but is nevertheless spaced apart from the housing wall, in particular in such a manner that each of the permanent magnets is held in a static installation position predetermined in each case with respect to an orientation and/or a smallest distance from one of the electrical coils of the base module and that a respective imaginary longitudinal axis of each of the permanent magnets and an imaginary longitudinal axis of at least one of the electrical coils are aligned with one another or run parallel to one another as an extension.

In the measuring systems in question, each vibronic module further has at least one (measuring) tube, for example at least partially straight and/or at least partially curved, with a tube wall forming an outer shell surface of the tube, in particular made of a metal or a plastic, and with a lumen encased by the same tube wall, in particular two essentially identical parallel (measuring) tubes, and each of the aforementioned permanent magnets is mounted on the outside of the tube wall, in particular at a first segment end and a second segment end, namely two essentially identical parallel (measuring) tubes, and each of the aforementioned permanent magnets is fixed to the outside of the tube wall, in particular to a central segment of the tube wall extending between a first segment end and a second segment end remote therefrom, in particular is connected to the tube wall by means of a material bond. In addition, the vibronic module or its at least one (measuring) tube is designed to be installed in the housing, if necessary without tools, in such a manner that the tube is placed at least partially, in particular completely, within the chamber, but is nevertheless spaced from the housing wall, and that each of the permanent magnets in the respective installation position together with the respective electrical coil form a voice coil, in particular serving as an electrodynamic oscillation exciter, and/or a plunger coil, in particular serving as an electrodynamic oscillation sensor. In the case of a (measuring) tube that is bent at least in portions, the aforementioned central segment can, for example, be essentially U-shaped or V-shaped.

In such a vibronic measuring system, each of the above-mentioned (measuring) tubes is also configured to carry a fluid measured substance flowing within the lumen during operation, in particular with a predeterminable flow direction and/or flow direction pointing from the first segment end to the second segment end, and to be vibrated in the meantime in order to generate measuring effects correlated with one or more measured variables of the measured substance, in particular in such a manner that the central segment performs oscillating movements about a static rest position and/or that the (measuring) tube is driven by means of at least one of the aforementioned (energized) voice coils and/or that an (alternating) voltage representing oscillating movements of the at least one tube and thus serving as an oscillation signal is generated by means of the aforementioned plunger coils. The measuring-system electronics of such a measuring system is in turn configured accordingly, by means of an electrical driver signal, in particular with an impressed alternating current and/or an impressed (alternating current) frequency essentially corresponding to a resonant frequency of the at least one tube, to feed electrical power into the at least one electrical coil forming the aforementioned voice coil and/or by means of the (alternating) voltage generated by the at least one electrical coil forming the aforementioned plunger coil, to determine measured values for the one or more measured variables to be detected for the measured substance flowing through the (measuring) tube or tubes, in the case of a measuring system designed as a Coriolis mass flow meter or measuring system designed as a Coriolis mass flow/density meter, for example, to generate (mass flow) measured values representing the mass flow on the basis of a (measured) phase difference, caused by Coriolis forces, between two of the aforementioned oscillation signals and a phase difference to measured value characteristic function set up in the measuring-system electronics. The phase difference to measured value mass flow characteristic function can, for example, be a (linear) parameter function with a (scale) zero point that corresponds to a (measured) phase difference of the two oscillation signals that can be measured when the measured substance is at rest or when the mass flow is zero, and with a slope which corresponds to a (measuring)sensitivity of the measuring system or a change in the (measuring)phase difference related to a change in the mass flow. Since one or more resonance frequencies of the at least one tube are particularly also dependent on the instantaneous density of the respective measured substance, by means of such a measuring system, in addition to the mass flow, the density of the respective measured substance flowing through it can also be measured directly by means of the (alternating current) frequency of the driver signal and/or by means of a (signal) frequency of at least one of the oscillation signals. Accordingly, the measuring-system electronics of measuring systems of the type in question are typically further equipped to generate (density) measured values representing the density on the basis of the aforementioned (alternating current) frequency of the driver signal and/or on the basis of a corresponding signal frequency of at least one of the oscillation signals, for example using an operation frequency to measured value characteristic curve function configured accordingly in the measuring-system electronics. Furthermore, it is also possible to directly measure the viscosity of the measured substance flowing through by means of vibronic measuring systems of the type in question, for example, based on an excitation energy or excitation power required to maintain the useful oscillations and/or based on a damping of the excited (resonance) oscillations resulting from a dissipation of oscillation energy or by using a damping-to-measured value characteristic curve function set up accordingly in the measuring system electronics. In addition, further measured variables derived from the aforementioned flow and/or substance parameters, such as the Reynolds number, can be easily determined by means of such vibronic measuring systems.

To simplify the commissioning of a measuring system formed in this manner, the vibronic module may further have at least one identifying element relating to or carrying identifying information about the vibronic module, for example a bar code, QR code or RFID label attached to at least one tube and/or the base module can have at least one light-emitting semiconductor element positioned within the (protective) housing and connected to the measuring-system electronics, for example a light-emitting diode (LED), and/or one or more radio transmitters/receivers (RF transceivers) and/or photosensors, for example one or more CCD photosensors and/or one or more CMOS photosensors, each positioned within the (protective) housing and connected to the measuring-system electronics.

Vibronic measuring systems of the type in question must also be regularly checked for their functional efficiency or any deviations from a respective reference state determined in advance, for example in the state determined by the manufacturer or in the manufacturer's factory and/or during a calibration or commissioning of the respective measuring system on site, for example, in order to be able to detect as early as possible any reductions in the functionality or measuring accuracy of the measuring system associated with increased deviations from the reference state, with which the measuring system ultimately maps the measured variable to be recorded, not least the mass flow and density, into the corresponding measured values. Such reductions in the functionality or measuring accuracy of such a measuring system can occur, for example, in the form of mostly irreversible changes in the electrical impedance of the above-mentioned swing and/or immersion coils and/or a permanently reduced stability of the mechanical connection between the base module and the vibronic module or the precision of the positioning of the vibronic module in the base module or can be caused, for example, by thermal and/or mechanical overloads, for instance as a result of very high or very low temperatures (i.e., in particular also temperatures lying outside the specification) within the base module, aging, increased or condensing moisture occurring within the base module and/or wear of components of the base module caused by frequent replacement of vibronic modules. Other influencing factors that at least indirectly and/or at least temporarily impair the functionality of the measuring system include multi-frequency and/or high-frequency electromagnetic (external) radiation or fields (EMC) propagating within the base module or (external) sound waves propagating within the base module, for example in the form of structure-borne sound.

As a result, it must regularly be assumed that one or more of the system functions (transfer functions) inherent in the measuring system, each of which characterizes a functional dependence of the aforementioned oscillation signals on the respective driver signal or one or more functional dependencies of the oscillation signals on the driver signal and the respective flow and/or material parameters of the measured substance, is also changed in comparison to a (reference) system function inherent in the respective original measuring transducer. Examples of such system functions of the measuring system include a mass flow to phase difference system function, in accordance with which the aforementioned (measuring) phase difference of the oscillation signals is dependent on the mass flow, or a density to resonance frequency system function of the transducer, in accordance with which one or more resonance frequencies of the at least one tube are dependent on the density of the measured substance. Equally affected by such (over)loading of the measuring transducer are accordingly also the measuring functions of the measuring system involving the aforementioned system functions, in accordance with which the measuring system as a whole converts the respective measured variable to be recorded into the respective measured values, for example a characteristic curve function composed of the aforementioned mass flow to phase difference system function and a phase difference to mass flow measured value characteristic curve function, namely a characteristic function implemented in the measuring-system electronics, in accordance with which a determined phase difference is converted into mass flow measured values, mass flow to measured value measuring function of the measuring system, in accordance with which mass flow measured values determined thereby are dependent on the mass flow. The phase difference-to-mass flow measured value characteristic curve function can, for example, be a (linear) parameter function with a (scale) zero point corresponding to a (measurement) phase difference measured when the measured substance is at rest and a (measurement) sensitivity corresponding to a change in the (measurement) phase difference related to a change in the mass flow (slope of the characteristic curve function). Further examples of such system functions that are also potentially affected by interference or measurement functions formed with them include a density-to-resonant-frequency-system function of the transducer or a density-to-measured-value-(measurement) function of the measurement system involving this and a resonant-frequency-to-density-characteristic function of the measurement system electronics and/or a viscosity-to-damping-system function of the transducer or a viscosity-to-measured-value-(measuring) function of the measuring system involving this and a damping-to-viscosity-measured-characteristic function of the measuring-system electronics. The change in the respective system function can accordingly have an effect, for example, as a drift of one or more of the respective characteristic curve parameters of one or more of the aforementioned characteristic curve functions, in the case of a linear parameter function, for example, of its zero point and/or its slope. The above-mentioned, possibly also irreversible changes to one or more of the system or measuring functions of the measuring system can occasionally also lead to the measuring system as a whole working incorrectly to such an extent that the high measuring accuracy typically envisioned for such measuring systems is no longer guaranteed, meaning that the functionality of the measuring system is considerably impaired, possibly even suspended, or that there is a correspondingly critical malfunction of the affected measuring system.

Taking this into account, measuring systems of the type in question are typically subjected to corresponding (re-)inspections, for example at regular intervals in the course of regular predictive maintenance; in such a manner that the functionality of the vibronic module or the totality of the measuring system is checked on site in the course of a time-controlled (self-)diagnosis carried out by means of the measuring system and/or triggered by corresponding control commands transmitted to the measuring-system electronics, approximately in order to be able to initiate appropriate repair or replacement measures as quickly as possible if necessary, not least when a malfunction of the measuring system is detected. In the case of a vibronic measuring system of the type in question, such a (repair or replacement) measure regularly involves replacing the defective vibronic module with a new vibronic module, which can also be carried out quickly and easily on site. However, one disadvantage of a test procedure in such a manner is that only the functionality of the measuring system as a whole can be verified or, conversely, that any malfunction detected cannot be localized exactly within the measuring system, i.e., assigned to the base module, the vibronic module or the measuring-system electronics. In particular, it is not readily possible with such a (self-)diagnosis to identify malfunctions of the base module or the measuring-system electronics electrically connected to it which merely impair the measuring accuracy, in such a manner that a need to replace the base module and/or the measuring-system electronics can also be determined in the course of such a check of a measuring system of the type in question.

Based on the aforementioned prior art, one object of the invention is to improve the checking of modular vibronic measuring systems in such a manner that any malfunctions or defects of the base module and/or the measuring-system electronics, not least also signs of wear or aging of the base module or the measuring-system electronics which reduce the measuring accuracy of the measuring system as a whole, can be detected as early and reliably as possible and, if necessary, also reported.

The object is accomplished by means of the test module according to claim 1, the test arrangement according to claim 17 and the method according to claim 30.

The test module according to the invention for a base module of a vibronic measuring system, in particular of a modular Coriolis mass flow meter, and/or for measuring-system electronics of the vibronic measuring system that are electrically connected to the base module, which test module comprises:
a mechanically connected, in particular electrical and/or magnetic and/or electronic first test element capable of vibrating, in particular when excited at an excitation frequency between 100 and 950 Hz, preferably at an excitation frequency of 300 Hz, is locked in the base module or is immovable, and/or that the first test element is held at a first predetermined test position within the base module.
According to an embodiment of the test module of the invention, the test module is further configured to be inserted into the base module and to be releasably mechanically connected thereto in such a manner that the first test element is held at a first test position which is predetermined in particular with respect to an orientation and/or a smallest distance of an electrical coil of the base module, for example also in such a manner that an imaginary longitudinal axis of the first test element and an imaginary longitudinal axis of an electrical coil of the base module are aligned with one another or run parallel to one another in extension.

According to an embodiment of the test module of the invention, it is further provided that the first test element has an electrical coil, in particular a cylindrical coil and/or designed as an air coil.

According to an embodiment of the test module of the invention, it is further provided that the first test element has a permanent magnet.

According to an embodiment of the test module of the invention, it is further provided that the carrier element is made at least partially of a, for example also chemically resistant and/or high-strength, plastic, such as a polycarbonate or a polyether ether ketone, mechanically connected environmental sensor, in particular spaced apart from the first test element, for detecting at least one physical environmental measured variable within the base module, in particular a multi-frequency and/or high-frequency electromagnetic environmental measured variable propagating within the base module into an environmental measurement signal.

According to a further development of the test module of the invention, this further comprises: at least one environmental sensor mechanically connected to the carrier element, for example spaced apart from the first test element, for detecting at least one physical environmental measured variable within the base module, for example a multi-frequency and/or high-frequency electromagnetic environmental measured variable propagating within the base module into an environmental measurement signal.

According to a further development of the test module of the invention, this further comprises: at least one identifying element, for example in particular relating to or carrying identifying information about the test module, for example a bar code label, a QR code label or a RFID label inserted and mechanically connected to the carrier element, and to be releasably mechanically connected thereto, that the first test element is held at a first test position predetermined in particular with respect to an orientation and/or a smallest distance from an electrical coil of the base module, in particular such that an imaginary longitudinal axis of the first test element and an imaginary longitudinal axis of an electrical coil of the base module are aligned with one another or run parallel to one another in extension, wherein the base module is configured to accommodate a vibronic module.

According to a further development of the test module of the invention, this further comprises: at least one environmental sensor mechanically connected to the carrier element, in particular spaced apart from the first test element, for detecting at least one physical environmental measured variable within the base module, in particular a multi-frequency and/or high-frequency electromagnetic environmental measured variable propagating within the base module into an environmental measurement signal.

According to an embodiment of the test module of the invention, it is further provided that the base module has:
a first electrical coil at least indirectly mechanically connected to at least one chamber of the placed, in particular cylindrical and/or electrically connected to the measuring-system electronics, which is at least partially encased by a housing wall. According to an embodiment of the test module of the invention, it is further provided that the test module is configured to be inserted into the base module and to be releasably mechanically connected thereto in such a manner that the carrier element and the first test element are placed within the chamber, in particular in such a manner that the first test element is held at a first test position predetermined with respect to an orientation and/or a smallest distance from the first electrical coil, and/or that an imaginary longitudinal axis of the first test element and an imaginary longitudinal axis of the first electrical coil are aligned with one another or run parallel to one another in extension.

According to a further development of the test module of the invention, this further comprises: at least one second test element for generating a magnetic field, which test element is mechanically connected to the carrier element and in particular is identical in construction to the first test element and/or is functionally identical to the first test element and/or is spaced apart from the first test element.

According to a further development of the test module of the invention, this further comprises: at least one third test element for generating a magnetic field, which test element is mechanically connected to the carrier element and in particular is identical in construction to the first and/or second test element, and/or is functionally identical to the first and/or second test element, and/or is spaced apart from the first and second test elements.

According to an embodiment of the test module of the invention, it is further provided that the test module is configured to be inserted into the first base module and to be releasably mechanically connected thereto in such a manner that the second test element is placed within the chamber, in particular in such a manner that the second test element is held at a second test position which is predetermined with respect to an orientation and/or a smallest distance from the second electrical coil and/or is spaced apart from the first test position, and/or in such a manner that an imaginary longitudinal axis of the second test element and an imaginary longitudinal axis of the second electrical coil are aligned with one another or run parallel to one another in extension.

According to an embodiment of the test module of the invention, it is further provided that the carrier element is designed such that, when excited to oscillate at the excitation frequency, the carrier element oscillates exclusively symmetrically with respect to a plane of symmetry of the carrier element due to a bending stiffness of the carrier element.

According to an embodiment of the test module of the invention, it is further provided that the carrier element comprises at least one solid, in particular non-medium-carrying rod, on which the first test element is arranged.

According to an embodiment of the test module of the invention, it is further provided that the carrier element comprises at least one, in particular planar, plate and preferably at least two plates running parallel to one another at least sectionally, wherein the first test element is arranged on the at least one plate.

According to an embodiment of the test module of the invention, it is further provided that the test module is designed such that, when excited to oscillate at the excitation frequency, the carrier element oscillates exclusively asymmetrically with respect to a plane of symmetry of the carrier element.

According to an embodiment of the test module of the invention, it is further provided that the carrier element has an asymmetric weight distribution.

According to an embodiment of the test module of the invention, it is further provided that the second test element and the third test element are arranged asymmetrically with respect to one another relative to a plane of symmetry of the carrier element.

According to an embodiment of the test module of the invention, it is further provided that a magnetic flux density of the second test element differs from the magnetic flux density of the third test element by at least 5%, in particular at least 15% and preferably at least 50%.

The test arrangement according to the invention comprises:
a test module according to the invention;
a base module of a vibronic measuring system, in particular of a modular Coriolis mass flow meter, for accommodating a vibronic module;
and measuring-system electronics of the vibronic measuring system;
wherein the base module has:
   a chamber with at least one at least partially encased by a housing wall
   at least one within the chamber of the is at least indirectly mechanically connected; wherein the test module is inserted into the base module and is mechanically fixedly connected thereto, but nevertheless detachably connected thereto, in such a manner that the carrier element and the first test element are placed within the chamber, in particular in such a manner that the test module is locked in the base module or is immovable, and/or that the first test element is held at a first test position predetermined with respect to an orientation and/or a smallest distance to the first electrical coil.

One embodiment of the test arrangement provides that the measuring-system electronics are designed to be fed by means of an electrical.

One embodiment of the test arrangement provides that the measuring system electronics are configured to provide the electrical driver signal with a signal frequency corresponding to a mechanical resonance frequency of the vibronic module.

One embodiment of the test arrangement provides that the base module has at least one second electrical coil which is placed within the chamber, is in particular cylindrical and/or designed as an air coil and/or is identical in construction to the first electrical coil, and which is at least indirectly mechanically connected, and the second electrical coil is electrically connected to the measuring-system electronics.

One embodiment of the test arrangement provides that the measuring-system electronics are configured to detect and evaluate a first electrical, in particular one inductively coupled into the second electrical coil by means of the second test element or induced in the second electrical coil, in particular using the first measured values for at least one parameter of the first, has at least one third electrical coil placed within the chamber of the housing, which is in particular cylindrical and/or designed as an air coil and/or identical in construction to the second electrical coil positioned, and is at least indirectly mechanically connected to the housing wall; and the third electrical coil is electrically connected to the measuring-system electronics.

One embodiment of the test arrangement provides that the measuring-system electronics are configured a second electrical measured value for at least one parameter of the second, in particular inductively coupled from the third test element into the third electrical coil or induced in the second electrical coil, placed within the chamber, but are nevertheless spaced apart from the housing wall, in particular in a static installation position which is predetermined with respect to an orientation and/or a smallest distance from the first electrical coil and/or corresponds to the first test position, and/or in such a manner that an imaginary longitudinal axis of the first permanent magnet and an imaginary longitudinal axis of the first electrical coil are aligned with one another or run parallel to one another in extension.

One embodiment of the test arrangement provides that the base module is configured to receive the vibronic module if the test module is not inserted into the base module; and/or the base module is configured to receive the test module if the vibronic module is not inserted into the base module; and/or the vibronic module and the base module are configured to be assembled without tools; and/or the test module and the base module are configured to be assembled without tools.

One embodiment of the test arrangement provides that the vibronic module is designed to be exchangeable, such that it can be brought into the chamber from outside the chamber and/or through a provided in the housing wall, and that it can be removed from the base module and/or through the.

One embodiment of the test arrangement provides that the test module is designed such that, when the carrier element is excited at the excitation frequency, a difference is set between a phase angle of a determined first chamber with at least one at least partially encased by a housing wall
and has at least one within the chamber of the at least indirectly mechanically connected and electrically connected to the measuring-system electronics,
and a vibronic module, in particular a vibronic module according to the invention; wherein the base module is configured to receive the vibronic module and to be connected thereto in a mechanically fixed, yet detachable manner, in particular by forming a measuring sensor of the vibration type or a vibronic measuring system and/or in such a manner that the vibronic module is immovable or is locked in the base module; which method comprises:
using a test module according to the invention to form a test arrangement according to the invention;
checking the base module and/or the measuring-system electronics by means of the test module of at least one measured value determined by means of the measuring system electronics with an associated reference value and/or at least one threshold value predetermined therefor;
removing the test module from the base module;
and inserting a vibronic module, in particular a vibronic module according to the invention, into the base module to form a measuring sensor of the vibration type or the vibronic measurement system.

According to one embodiment of the method of the invention, forming the test arrangement further comprises inserting the test module into the base module, for example after a vibronic module has been removed from the base module or for commissioning.

According to a further development of the method of the invention, this further comprises integrating the test arrangement into a superordinate electronic data processing system. The data processing system can also be formed, for example, by means of a programmable logic controller and/or by means of a process control system and/or by means of an edge (computing) device and/or by means of a cloud (computing) system.

One of the basic ideas of the invention is to use the installation space provided by the respective base module of a modular vibronic measuring system for a vibronic module installed in (normal) measuring operation also for occasionally a test module serving to check the basic module and/or the measuring system electronics connected thereto instead of such a vibronic module, in such a way that the test module is installed in the same way as the respective vibronic module with the base module for the purpose of forming a test arrangement. One advantage of the invention is that it allows a base module or measuring-system electronics of a modular vibronic measuring system to be checked in a very simple manner on site, in particular also in situ or without having to remove the already installed base module or the already installed measuring-system electronics. In the case of vibronic modules to be used only once or only for a specified period of time (“single-use”), such a check can also be carried out advantageously as part of a planned or regular replacement of the vibronic module previously installed in the respective base module with a new vibronic module.

The invention as well as advantageous embodiments thereof are explained in more detail below based upon exemplary embodiments shown in the figures of the drawing. Identical or identically acting or identically functioning parts are provided with the same reference signs in all figures; for reasons of clarity or if it appears sensible for other reasons, reference signs mentioned before are dispensed with in subsequent figures.

Further advantageous embodiments or developments, especially, combinations of partial aspects of the invention that were initially explained only separately, furthermore emerge from the figures of the drawing and/or from the claims themselves.

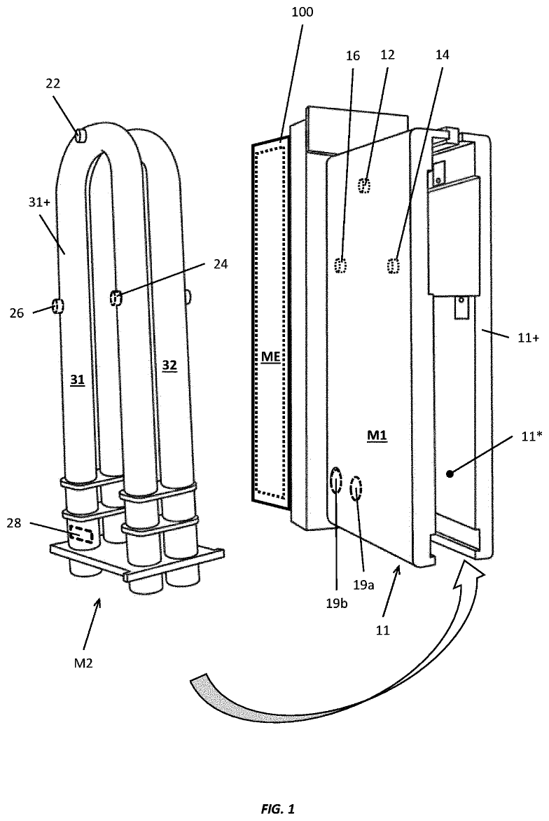

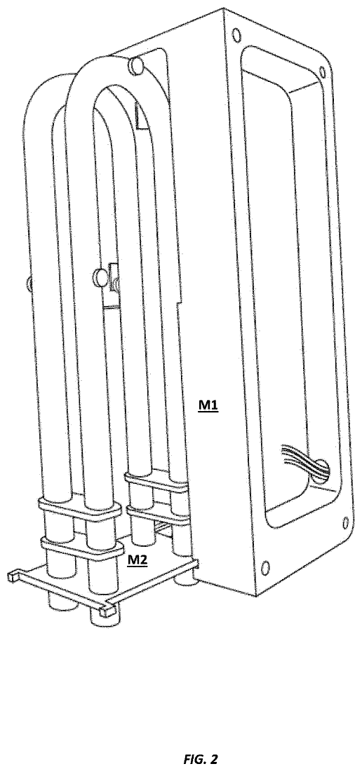

The figures show in detail:
FIGS. 1, 2 show an exemplary embodiment of a base module, measuring-system electronics and a vibronic module of a modular vibronic measuring system (still to be assembled);

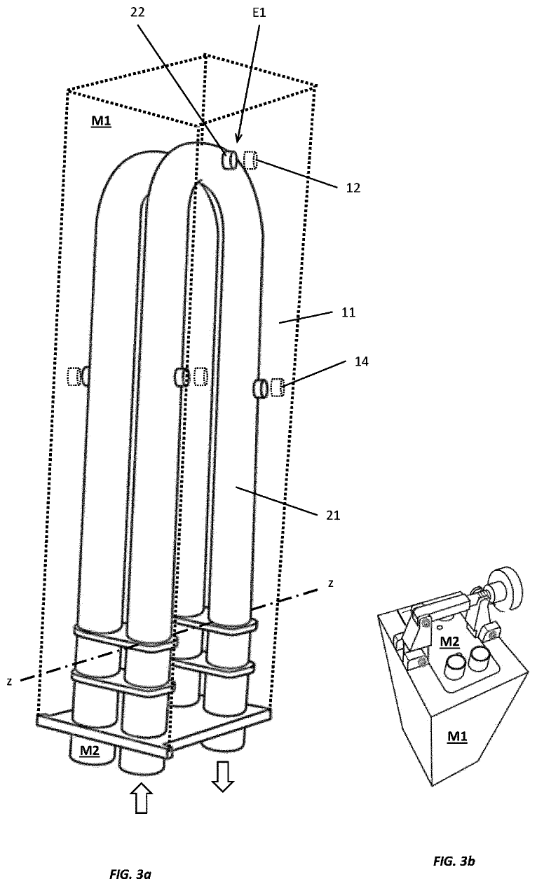

FIGS. 3a, 3b show different side views of an exemplary embodiment of the modular vibronic measuring system in accordance with FIG. 1; and

FIG. 4, 5, 6, 7a-d show exemplary embodiments of test modules.

FIGS. 1, 2, 3a and 3b schematically show an exemplary embodiment of a (modular) vibronic measuring system which is intended in particular to detect at least one measured variable of a fluid measured substance flowing in a (measured substance) line, namely to determine measured values for one or more measured variables, for example a mass flow, a volume flow, a density and/or a viscosity, of the measured substance. For this purpose, the measuring system comprises a base module M1, a vibronic module M2 and, for example, programmable measuring-system electronics ME. The measuring-system electronics ME can, for example, be formed by means of one or more microprocessors (μC) and/or have a display and operating element, for example formed by means of a touch display, for example for displaying measurement and/or operating data of the measuring system. The base module M1 has a (protective) housing 11 with at least one chamber 11* at least partially encased by a housing wall 11+ and at least one first electrical coil 12, for example cylindrical and/or designed as an air coil, which is placed within the chamber 11* of the (protective) housing and is at least indirectly mechanically connected to the housing wall 11+ and electrically connected to 31 the measuring-system electronics ME, and the vibronic module M2 has at least one, for example cylindrical, first permanent magnet 22. The measuring-system electronics ME can, as is quite common in measuring systems of the type in question, also be housed at least partially within the chamber 11* and/or at least partially outside the chamber 11*, in particular within an electronics housing 100 of the measuring system, or be designed in a modular manner. The measuring system can, for example, be designed as a modular Coriolis mass flow meter and/or correspond to one of the vibronic measuring systems in patent applications WO 2019/017891A1 , WO 2021121867A1 , DE 102021105397.8, DE 102020133614.4, DE 102020132685.8, DE 102020133851.1, DE 102020133566.0, DE 102020132986.5, DE 102020132686.6, DE 102020132685.8, DE 102020131452.3, DE 102020132223.2, DE 102020127356.8, DE 102020114519.5 and DE 102020112154.7 mentioned at the beginning.

The base module M1 is, as shown schematically in FIGS. 3a and 3b or as can be readily seen from a combination of FIGS. 1, 2, 3a and 3b, configured in particular to receive the vibronic module M2 and to be connected thereto in a mechanically fixed but nevertheless detachable manner, for example in such a manner that the vibronic module M2 is locked in the base module M2, and/or in such a manner that the vibronic module can also be (subsequently) retrofit on site, namely in a base module already installed (in a plant). In particular, the base module M1 and the vibronic module M2 are further configured to be assembled or assembled to form a vibration-type measuring sensor (of the measuring system) so that an electro-mechanical oscillation exciter and/or an (electro-dynamic) oscillation sensor of the measuring system is formed by means of the electrical coil 12 (connected to the measuring-system electronics ME) and by means of the permanent magnet 22. According to a further embodiment of the invention, the vibronic module is particularly configured to be installed in the base module in such a manner that its permanent magnet 22 is placed within the chamber 11*, but is nevertheless spaced from the housing wall 11+, namely in particular in a static (first) installation position E1 predetermined with respect to an orientation and/or a smallest distance from the electrical coil 12, and/or is held in such a manner that an imaginary longitudinal axis of the first permanent magnet and an imaginary longitudinal axis of the electrical coil 12 are aligned with one another or run parallel to one another in extension. In particular, the permanent magnet 22 is further configured to form a voice coil, for example serving as an electrodynamic oscillation exciter, and/or a plunger coil, for example serving as an electrodynamic oscillation sensor, in installation position E1 together with the electrical coil 12. According to a further embodiment of the invention, the vibronic module M2 and the base module M1 are further configured, in particular also on site, to be assembled without tools and/or disassembled again, in particular non-destructively, in such a manner that the vibronic module can be removed again from the base module M1 non-destructively. Alternatively or in addition, the vibronic module M2 is designed in particular to be replaceable or configured to be removable, in particular non-destructively, in particular also on site from outside the housing and/or through an (insertion) opening of the (protective) housing 11 provided in the housing wall 11+, and/or the vibronic module M2 is configured in particular also on site, to be installed in the base module M1, in particular in such a manner that it can be inserted into the chamber 11* from outside the (protective) housing 11 or through the (insertion) opening. This can be done, for example, without having to handle the base module M1 itself or remove it from the respective (process) plant. The aforementioned (slide-in) opening can also, if necessary, be sealed after installation of the vibronic module by means of an appropriate cover, for example also dust-tight and/or tight against strong water jets and/or explosion-proof. As a result, it is also possible to easily replace a defective or worn (old) vibronic module on site with an intact new vibronic module, which may only be used once or only for a specified period (“disposable”). In order to support correct installation of the vibronic module M2 into the base module M1, the vibronic module M2 and base module M1 can each have corresponding guide structures or elements, for example corresponding (guide) grooves in one of the two modules (M1, M2) and (guide) springs and/or (guide) pins in the other of the two modules that slide therein during assembly. To further simplify the commissioning of the measuring system, the vibronic module M2 can further comprise at least one identification element 28, for example a bar code, QR code or RFID label (RFID TAG), which relates to or carries identifying information about the vibronic module M2, and/or the base module M1 can have at least one light-emitting semiconductor element 19a, for example a light-emitting diode (LED), positioned within the (protective) housing and connected to the measuring-system electronics (into the chamber 11*) for reading the identifying element 28, and/or one or more radio transmitters/receivers (RF transceivers), each positioned within the (protective) housing and connected to the measuring-system electronics, and/or photosensors 19b (sensitive to light illuminating the chamber 11*), for example namely one or more CCD photosensors and/or one or more CMOS photosensors.

According to a further embodiment of the invention, the vibronic module M2 has at least one second permanent magnet 24 positioned at a distance from the permanent magnet 22, in particular cylindrical and/or identical in construction to the permanent magnet 22. Further, the base module M1 accordingly has at least one second electrical coil 14 placed within the chamber 11* of the (protective) housing, for example cylindrical and/or designed as an air coil and/or identical in construction to the first electrical coil 12, which (remote from the electrical coil 12) is at least indirectly mechanically connected to the housing wall 11+ and is also electrically connected to the measuring-system electronics, and the base module is furthermore configured to receive the vibronic module in such a manner that the permanent magnet 24 is held in a second installation position, in particular with respect to an orientation and/or remote from the first installation position, or that an imaginary longitudinal axis of the permanent magnet 24 and an imaginary longitudinal axis of the electrical coil 14 are aligned with one another or are parallel to one another as an extension. In addition, the vibronic module M2 can also have more than two permanent magnets (22, 24) arranged at a distance from one another, thus at least one third permanent magnet 26, and the base module M1 can have more than two electrical coils (12, 14) arranged at a distance from one another within the chamber 11*, thus at least one third air coil 16.

According to a further embodiment of the invention, the vibronic module M2 has at least one (first) tube 31 with a tube wall forming an outer shell surface of the tube 31, for example made of a metal or a plastic, and with a lumen 21* wrapped by the same tube wall, and the permanent magnet 22 is fixed to the outside of the tube wall, for example connected to it by a material bond. As shown schematically in FIG. 1, the at least one tube 31 can be straight at least sectionally and/or curved at least sectionally, for example in such a manner that a central segment of the tube wall extending between a first segment end and a second segment end of the tube wall remote therefrom is designed to be U-shaped or V-shaped and/or that, as also shown schematically in FIG. 1, the at least one permanent magnet 22 is attached to the outside of the aforementioned central segment. The aforementioned permanent magnet 24 and/or other permanent magnets (26) of the vibronic module M2 can also be attached to the outside of the central segment, for example. Further, the at least one tube 31 is also intended, inter alia, to be incorporated into the base module M1 in the manner described above and also to be incorporated into the course of a (measured substance) line, for example a hose line or a plumbing line. In addition, the at least one tube 31 is configured in particular to carry in its lumen a fluid measured substance flowing, in particular at least temporarily, in a predeterminable direction of flow, for example from the aforementioned first segment end to the aforementioned second segment end, for example via the aforementioned (measured substance) line, and to be vibrated in the process; in particular also in such a manner that the at least one tube 31 performs forced bending or resonance oscillations about a static rest position and/or that the at least one permanent magnet 22 is moved relative to the electrical coil 12. Such mechanical oscillations of the at least one (measuring) tube 31 or its central segment can, for example, be excited or maintained by means of the above-mentioned oscillation exciter formed by means of the permanent magnet 22 and the coil 12 and/or detected by means of the above-mentioned oscillation sensor formed (by means of the permanent magnet 22 and the coil 12) in particular in such a manner that at least one oscillation signal representing the same oscillations of the tube 31 or its central segment is provided by the oscillation sensor. Not least in order to enable such vibrations of the at least one (measuring) tube 31, in particular of the aforementioned central segment, the vibronic module M2 according to a further embodiment of the invention is further configured to be installed in base module M1 or its (protective) housing 11 in such a way that, as also shown schematically in FIG. 3a, the at least (measuring) tube 31 is placed at least partially, for example also completely, within the chamber 11*, nevertheless at least its aforementioned central segment is spaced apart from the housing wall 11+.

As is quite usual with such vibronic modules or vibronic measuring systems formed therewith, the vibronic module M2 can furthermore have at least one second (measuring) tube 32, for example also identical in construction and/or function to the first tube, with a tube wall forming an outer shell surface of the second tube, in particular made of a metal or a plastic, and with a lumen encased by the same tube wall. In this case, the aforementioned second permanent magnet 24 can, for example, namely vis-a-vis the permanent magnet 22 fixed to the first tube 31, also be fixed to the second tube, in particular, namely connected thereto by a material connection; this, for example, also in such a manner that an imaginary longitudinal axis of the permanent magnet 24 and an imaginary longitudinal axis of the permanent magnet 22 are aligned with one another or run parallel to one another in extension. The first and second (measuring) tubes 31, 32 can also be fluidically connected to one another by means of a first flow divider on the inlet side and a second flow divider on the outlet side, as is quite common in vibronic measuring systems of the type in question, and may also be integrated into the course of the aforementioned (measured substance) line during operation of the measuring system. Not least for the case described above in which the vibronic module M2 is formed by means of two tubes (31, 32), the vibronic module M2 can also have more than three permanent magnets arranged at a distance from one another, for example at least six permanent magnets in total, and the base module M1 can accordingly have more than three electrical coils arranged at a distance from one another within the chamber 11*, for example at least six electrical coils in total, for example also each designed as air coils.

In order to excite and maintain mechanical oscillations of the at least one (measuring) tube 31 or of the vibronic module M2 formed therewith, the measuring-system electronics ME are, according to a further embodiment, also configured to provide a first electrical (measuring system) driver signal and to introduce it into at least one of the electrical coils (12, 14) of the base module M2, for example namely the coil 12 and/or the aforementioned coil 14, in order to feed electrical power required for the aforementioned mechanical oscillations into the at least one electrical coil; in particular in such a manner that the at least one (measuring system) driver signal has an impressed alternating current and/or at least one signal frequency corresponding to a mechanical resonance frequency of the vibronic module M2, in particular its at least one (measuring) tube 31. In the aforementioned case that the base module M1 also comprises at least the electrical coil 14 in addition to the electrical coil 12, the measuring-system electronics ME can further be configured to feed electrical power into the second electrical coil 14 by means of a second electrical (measuring system) driver signal, in particular with an impressed alternating current and/or with a signal frequency corresponding to a mechanical resonance frequency of the vibronic module or its at least one (measuring) blade and/or simultaneously with the first driver signal.

According to another embodiment of the invention, the measuring-system electronics ME are also configured, for example, to detect and evaluate a first electrical (alternating) voltage induced, for example, in the electrical coil 12 and/or in the aforementioned coil 14 by the electrical coil 12 (14), for example, using the (alternating) voltage to determine (parameter) measured values for at least one parameter of the (alternating) voltage, such as for instance an amplitude, a frequency and/or a phase angle, and/or to calculate measured values for the measured variable to be detected at least by the measured substance based on the (alternating) voltage or (parameter) measured values determined therefor. Furthermore, the measuring-system electronics ME can also be configured to calculate measured values for an inductance of the electrical coil based on the (AC) voltage or (parameter) measured values determined for this purpose, for example in order to accordingly take these into account when checking a functionality of the measuring system or in order to compare the determined inductance of the first electrical coil 12 with a previously determined (inductance) reference value and/or one or more threshold values predetermined for this purpose. Alternatively or additionally, the measuring-system electronics ME can, for example, also be configured to compare one or more of the aforementioned (parameter) measured values with one or more (parameter) reference values determined in advance for this purpose and/or one or more threshold values predetermined for this purpose in order to check the functionality of the measuring system. In the aforementioned case that the base module M1 also comprises at least the electrical coil 14 in addition to the electrical coil 12, the measuring-system electronics can also be configured to detect and evaluate a second electrical (alternating) voltage induced in the coil 14 by the second electrical coil, for example, to calculate (parameter) measured values for the at least one parameter of the second (alternating) voltage and/or a phase difference established between the first and second (alternating) voltages on the basis of the second (alternating) voltage, for example in order to calculate measured values for the at least one measured variable to be detected by the measured substance. According to a further embodiment of the invention, the measuring-system electronics are in particular also configured to use a phase difference established between the first and second (alternating) voltages to obtain measured values for at least one measured variable, in particular a mass flow, of a flowing fluid and/or the measuring-system electronics are configured to determine and evaluate (parameter) measured values for the aforementioned phase difference, for example to compare one or more (parameter) measured values for the phase difference with a previously determined (parameter) reference value and/or one or more threshold values predetermined for this purpose. Alternatively or in addition, the measuring-system electronics may further be configured to determine measured values also for an inductance of the second electrical coil.

In order to be able to check or verify the functionality of the base module M1 itself and/or of the measuring-system electronics ME electrically connected thereto or of the subsystem thus formed very easily, if necessary also on site during commissioning and/or recurrently, a corresponding test module PM (FIG. 4 to 7) is proposed or provided in accordance with the invention, which has a, for example monolithic and/or plate-shaped and/or tube-shaped, carrier element 41 and at least one first test element 42 for generating a magnetic field, which test element is in particular electrical and/or magnetic and/or electronic and/or arranged on a printed circuit board of the test module PM, and is mechanically connected to the carrier element 41, for example namely a permanent magnet. The carrier element 41 can, for example, consist of or be produced from metal and/or a plastic, for example also at least partially embedding the at least one test element 41 or the aforementioned printed circuit board, for example also in such a manner that an outer protective layer of the carrier element 41 is formed by means of the aforementioned plastic. The aforementioned plastic can, for example, be a chemically resistant and/or high-strength plastic, such as a polycarbonate (PC) or a polyether ether ketone (PEEK).

The test module PM according to the invention is further particularly intended or designed to be used to form a test arrangement (PM+M1; PM+M1+ME), namely to be inserted (instead of the vibronic module M2) into the base module M1 and to be releasably mechanically connected thereto, in such a manner that the carrier element 41 and the first test element 42 are placed within the chamber 11+; in particular in the same manner as the vibronic module M2 or in such a manner that the test module PM is locked in the base module M1 or is immovable. In particular, the test module PM is furthermore configured to be installed in the base module M1 in such a way that the first test element 42 is held in a first test position P 1 predetermined by the first electrical coil 12 of the base module or corresponding to the aforementioned first installation position, for example also in such a manner that the first test element 42 held in the first test position P1 has a predetermined orientation and/or a predetermined smallest distance from the first electrical coil 12 and/or that an imaginary longitudinal axis of the first test element and an imaginary longitudinal axis of the first electrical coil 12 are aligned with one another or run parallel to one another in extension. In the above-mentioned case that the test element 42 has an electrical coil, the test element 42 together with the electrical coil 12 of the base module M1 can, for example, form a transformer and in the other case mentioned that the test element 42 has a permanent magnet, the test element 42 together with the electrical coil 12 of the base module M1 can, for example, also form a magnetic coil. In order to support the correct installation of the test module PM into the base module M1, the test module PM can also have the aforementioned guide structures or elements of the vibronic module M2 corresponding to or corresponding with the aforementioned guide structures or elements of the base module M1.

Not least for the aforementioned case that the base module M1 has several electrical coils, for example at least the coil 14, the test module PM can furthermore have in a corresponding manner at least one test element 44 mechanically connected to the carrier element 41, for example structurally and/or functionally identical to the first test element 42 and/or spaced apart from the first test element, second test element for generating and/or detecting a magnetic field, possibly also additionally having at least one third test element 46 for generating and/or detecting a magnetic field, which is mechanically connected to the carrier element 41 and in particular is structurally and/or functionally identical to the first and/or second test element and/or is spaced apart from the first and second test elements. Further, the test module PM may be configured to be inserted into the first base module M! and to be releasably mechanically connected thereto in such a manner that each of the aforementioned test elements is placed within the chamber 11+, for example, in such a manner that the second test element 44 is held at a second test position which is predetermined with respect to an orientation and/or a smallest distance from the second electrical coil 14 and/or is spaced from the first test position P1 and/or corresponds to the aforementioned second installation position, and/or that an imaginary longitudinal axis of the second test element 44 and an imaginary longitudinal axis of the second electrical coil 14 are aligned with one another or run parallel to one another in extension.

Not least for the case described above, in which the base module M1 together with the measuring-system electronics ME are configured to be able to read out an identification element 28 of the vibronic module M2, the test module can further comprise at least one identification element 48, in particular carrying information relating to or identifying the test module, which is mechanically connected to the carrier element in order to simplify the commissioning of the test arrangement thus formed, for example a bar code label, a QR code label or a radio label (RFID TAG) and, in addition, the measuring-system electronics ME can also be configured to read out information carried by the identification element 48 of the test module PM from the identification element 48, in particular to evaluate it, for instance in order to verify whether the test module PM is compatible with the base module M1 and/or the measuring-system electronics ME or is authorized to form the test arrangement.

FIG. 4 shows a test module 41 which is substantially similar to a vibronic module according to the invention or is designed identically to a vibronic module. The tubes 31 and 32 are configured to carry the medium for which the mass flow, the volume flow, the density and/or the viscosity is determined. The first test element 42—in the form of a permanent magnet—forms, in combination with the first electrical coil of the base module, a coil driver system via which the tube 31 can be set into mechanical oscillations. The second test element 44 and the third test element 46 are also arranged on the carrier element 41. Both test elements, in conjunction with a second electrical coil or third electrical coil, form a coil sensor system which is configured to detect the mechanical oscillation of the tube 31. The test module is a previously calibrated (gold standard) vibronic module with which the base module and/or the measuring-system electronics are checked using the at least one measured value determined by the measuring-system electronics with an associated reference value and/or at least one threshold value predetermined therefor.

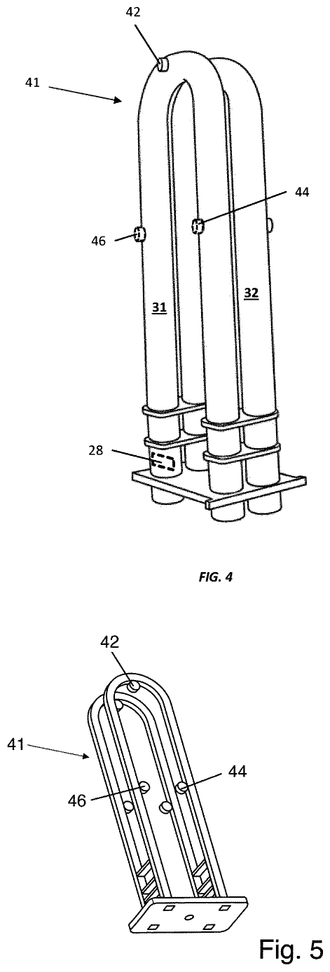

FIG. 5 shows an alternative test module 41. Instead of the medium-carrying tube, at least one solid, in particular U-shaped, metallic rod is provided on which the first test element 42, the second test element 44 and the third test element 46 are arranged. The illustrated embodiment has two bars running parallel to each other, on each of which three test elements are arranged.

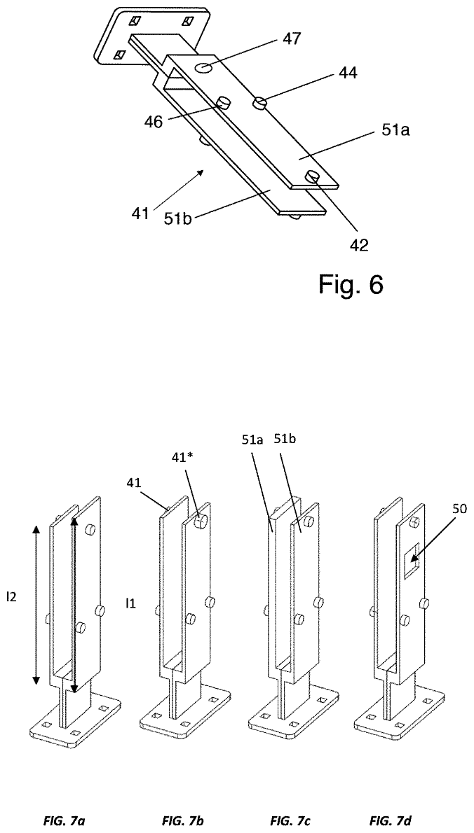

FIG. 6 shows an alternative test module 41. The carrier element 41 comprises at least one plate 51, in particular designed solid and planar. The three test elements 42, 44, 46 are arranged on the plate 51a. In addition, an environmental sensor is arranged on the surface of the plate 51. The illustrated embodiment comprises exactly two planar plates 51a, 51b running substantially parallel to each other, on each of which three test elements are arranged.

FIG. 7a-d show four embodiments of test modules which are designed in such a way that, when used in the basic module, during measurement, a mass flow is simulated, or a phase difference between the two measurement signals of the at least two sensor systems is detected. In the embodiment according to FIG. 7a, an asymmetric weight distribution is implemented by providing plates of different lengths. The plate 51a has a length 11 and the plate 51b has a length 12. The length 11 is different from the length 12. In the illustrated embodiment, the length 11 is greater than the length 12. The test elements are substantially identical in construction.

The embodiment of FIG. 7b differs from the embodiment of FIG. 6 substantially in that the magnetic field strength of the magnetic field generated by the first test element 41 of the first (measuring) tube differs substantially, i.e., significantly outside the tolerance limits for test elements of the same construction, from the magnetic field strength of the magnetic field generated by the first test element 41* of the second (measuring) tube. In the illustrated embodiment, this is achieved due to the different sizes of the test elements (i.e., in this case, of the permanent magnets). The first test element 41 has a significantly smaller test element diameter than the first test element 41*. The lengths of the plates are essentially identical. The difference in the generated magnetic field strengths is at least 5%, in particular at least 15% and preferably at least 50%.

The embodiment of FIG. 7c differs from the embodiment of FIG. 6 substantially in that the two utilized plates 51a, 51b have different material thicknesses. In the illustrated embodiment, the plate 51a has a substantially greater material thickness or plate thickness than the plate 51b. The test elements are substantially identical in construction.

The embodiment of FIG. 7d differs from the embodiment of FIG. 6 substantially in that the plate 51b has a material density that is spatially variable in its own longitudinal direction, while the plate 51a has a spatially constant material density distribution. In the illustrated embodiment, the plate 51b has an opening 51a for this purpose.

1-31. (canceled)

32. A test module for a base module of a vibronic measuring system and/or measuring-system electronics, wherein the measuring-system electronics are electrically connected to the base module, and wherein the vibronic measuring system is a modular Coriolis mass flow meter, the test module comprising:
a carrier element configured to oscillate when excited with an excitation frequency of between 100 and 950 Hz, wherein the carrier element is made of metal and/or plastics material; and
at least one electrical and/or magnetic and/or electronic test element mechanically connected to the carrier element for generating a magnetic field, wherein the at least one test element is a permanent magnet, and wherein the at least one test element includes a first test element,
wherein the test module is configured to be inserted into the base module and to be releasably mechanically connected thereto such that the test module is locked in the base module or is immovable and/or that the first test element is held within the base module at a predetermined first test position.

33. The test module according to claim 32, wherein the first test position is predetermined with respect to an orientation and/or a smallest distance from an electrical coil of the base module such that an imaginary longitudinal axis of the first test element and an imaginary longitudinal axis of the electrical coil of the base module are aligned with each other or extend parallel to each other,
wherein the base module is configured to accommodate a vibronic module.

34. The test module according to claim 32, further comprising:
at least one environmental sensor mechanically connected to the carrier element and spaced apart from the first test element, the at least one environmental sensor configured to detect at least one physical environmental measured variable within the base module and to convert the detected measured variable into an environmental measurement signal,
wherein the at least one measured variable is at least one of: multi-frequency and/or high-frequency electromagnetic interference radiation propagating within the base module, sound waves propagating within the base module, thermal radiation propagating within the base module, a temperature within the base module, and a humidity within the base module.

35. The test module according to claim 32, wherein the base module includes:
a housing including at least one chamber at least partially encased by a housing wall; and
at least one electrical coil disposed within the chamber of the housing and electrically connected to the measuring system electronics, which is at least indirectly mechanically connected to the housing wall.

36. The test module according to claim 35, wherein the at least one electrical coil includes a first electrical coil,
wherein the test module is configured to be inserted into the base module and to be releasably mechanically connected thereto such that the carrier element and the first test element are disposed within the chamber such that the first test element is held at the first test position predetermined with respect to an orientation and/or a smallest distance from the first electrical coil, and/or such that an imaginary longitudinal axis of the first test element and an imaginary longitudinal axis of the first electrical coil are aligned with each other or extend parallel to each other.

37. The test module according to claim 32, wherein the at least one test element includes a second test element mechanically connected to the carrier element, the second test element identical in construction to the first test element and/or functionally identical to the first test element and/or spaced apart from the first test element, the second test element configured for generating a magnetic field.

38. The test module according to claim 32, wherein the at least one test element includes a third test element mechanically connected to the carrier element, the third test element identical in construction to the first and/or second test element and/or is functionally identical to the first and/or second test element and/or is spaced apart from the first and second test elements, the third test element configured for generating a magnetic field.

39. The test module according to claim 37, wherein the at least one electrical coil includes a first electrical coil,
wherein the test module is configured to be inserted into the base module and to be releasably mechanically connected thereto such that the second test element is disposed within the chamber such that the second test element is held at a second test position, which is predetermined with respect to an orientation and/or a smallest distance from the second electrical coil and/or is spaced apart from the first test position, and/or such that an imaginary longitudinal axis of the second test element and an imaginary longitudinal axis of the second electrical coil are aligned with each other or extend parallel to each other.

40. The test module according to claim 32, wherein the carrier element is adapted such that, when excited to oscillate at the excitation frequency, the carrier element oscillates exclusively symmetrically with respect to a plane of symmetry of the carrier element due to a bending stiffness of the carrier element.

41. The test module according to claim 32, wherein the carrier element comprises at least one solid, non-medium-carrying rod on which the first test element is arranged.

42. The test module according to claim 32, wherein the carrier element comprises at least one planar plate, wherein the first test element is arranged on the at least one plate.

43. The test module according to claim 32, wherein the at least one planar plate includes exactly two plates extending parallel to each other at least sectionally.

44. The test module according to claim 32, wherein the test module is adapted such that, when excited to oscillate at the excitation frequency, the carrier element oscillates exclusively asymmetrically with respect to a plane of symmetry of the carrier element.

45. The test module according to claim 44, wherein the carrier element has an asymmetric weight distribution.

46. The test module according to claim 44, wherein:
the at least one test element includes a second test element and a third test element, each mechanically connected to the carrier element;
the test module is adapted such that, when excited to oscillate at the excitation frequency, the carrier element oscillates exclusively asymmetrically with respect to a plane of symmetry of the carrier element; and
the second test element and the third test element are arranged asymmetrically with respect to each other relative to the plane of symmetry of the carrier element.

47. The test module according to claim 32, wherein the at least one test element includes a second test element and a third test element, each mechanically connected to the carrier element, and
wherein a magnetic flux density of the second test element differs from a magnetic flux density of the third test element by at least 5%.

48. The test module according to claim 47, wherein the magnetic flux density of the second test element differs from the magnetic flux density of the third test element by at least 50%.

49. The test module according to claim 32, wherein the excitation frequency is 300 Hz.

50. A use of the test module according to claim 32 for testing a base module of a vibronic measuring system and/or modular measuring-system electronics of the vibronic measuring system electrically connected to the base module.

51. A test arrangement, comprising:
the test module according to claim 32;
a base module of a vibronic measuring system configured to accommodate a vibronic module; and
measuring system electronics of the vibronic measuring system,
wherein the base module includes:
a housing including at least one chamber at least partially enclosed by a housing wall; and
a first electrical coil disposed within the chamber of the housing, which is at least indirectly mechanically connected to the housing wall,
wherein the test module is installed into the base module and is mechanically, fixedly and detachably connected thereto such that the carrier element and the first test element are arranged within the chamber such that the test module is locked in the base module or is immovable and/or such that the first test element is held at a first test position predetermined with respect to an orientation and/or a smallest distance to a first electrical coil of the base module.

52. The test arrangement according to claim 51, wherein the measuring system electronics are configured to supply electrical power into the first electrical coil via an electrical driver signal with an impressed alternating current.

53. The test arrangement according to claim 51, wherein the measuring system electronics are configured to provide the driver signal with a signal frequency corresponding to a mechanical resonance frequency of the vibronic module.

54. The test arrangement according to claim 51, wherein the base module includes a second electrical coil disposed within the chamber of the housing, which second electrical coil is configured as an air coil and/or is identical in construction to the first electrical coil, and which, spaced at a distance from the first electrical coil, is at least indirectly mechanically connected to the housing wall, and
wherein the second electrical coil is electrically connected to the measuring-system electronics.

55. The test arrangement according to claim 54, wherein the measuring system electronics are configured to detect and evaluate a first voltage from the second electrical coil, which is inductively coupled into the second electrical coil from a second test element, or induced in the second electrical coil, using the first voltage to determine measured values for at least one parameter of the first voltage and/or measured values for at least one measured variable of a flowing fluid measured substance and/or an inductance of the first electrical coil,
wherein the at least one parameter of the first voltage is at least one of an amplitude, a frequency, and a phase angle.

56. The test arrangement according to claim 55, wherein the measuring system electronics are configured to determine an inductance of the second electrical coil based on the first voltage and to compare the determined inductance of the second electrical coil with a previously determined reference inductance value and/or one or more threshold values predetermined therefor, and/or
wherein the measuring system electronics are configured to determine the parameter measured values for the at least one parameter of the first and to compare the parameter measured values with a previously determined reference parameter value and/or one or more threshold values predetermined therefor.

57. The test arrangement according to claim 51, wherein the base module includes a third electrical coil disposed within the chamber of the housing, which second electrical coil is configured as an air coil and/or is identical in construction to the second electrical coil, and which, spaced at a distance from the second electrical coil, is at least indirectly mechanically connected to the housing wall; and
wherein the third electrical coil is electrically connected to the measuring system electronics.

58. The test arrangement according to claim 57, wherein the measuring system electronics are configured to detect and evaluate a second voltage from the third electrical coil, which is inductively coupled into the third electrical coil from a third test element, or induced in the second electrical coil, using the second voltage to determine measured values for at least one parameter of the second voltage and/or to determine measured values for at least one measured variable of a flowing fluid and/or an inductance of the second electrical coil,
wherein the at least one parameter of the second voltage is at least one of an amplitude, a frequency, a phase angle, and a phase difference established between the first and second voltages.

59. The test arrangement according to claim 58, wherein the measuring system electronics are configured to determine and evaluate parameter measured values for a phase difference established between the first and second voltages and to compare one or more parameter measured values for the phase difference with a previously determined reference parameter value and/or one or more threshold values predetermined therefor, and/or
wherein the measuring system electronics are configured to determine measured values for at least one measured variable, wherein the at least one measured variable is a mass flow of a flowing fluid based on the phase difference established between the first and second voltages.

60. The test arrangement according to claim 59, wherein the vibronic module is configured to be installed in the base module such that the permanent magnet is disposed within the chamber and spaced apart from the housing wall in a static installation position, which is predetermined with respect to an orientation and/or a smallest distance from the first electrical coil and/or corresponds to the first test position, and/or such that an imaginary longitudinal axis of the first permanent magnet and an imaginary longitudinal axis of the first electrical coil are aligned with each other or extend parallel to each other.

61. The test arrangement according to claim 51, wherein at least one of:
the base module is configured to receive the vibronic module when the test module is not installed into the base module;
the base module is configured to receive the test module when the vibronic module is not installed into the base module;
the vibronic module and the base module are configured to be assembled without tools; and
the test module and the base module are configured to be assembled without tools.

62. The test arrangement according to claim 61, wherein the vibronic module is adapted to be exchangeable so as to be brought into the chamber from outside the housing of the base module and/or through an opening of the housing provided in the housing wall and so as to be removed from the base module, non-destructively and/or without tools, from outside the housing and/or through the opening of the housing.

63. The test arrangement according to claim 51, wherein the test module is configured such that, when the carrier element is excited at the excitation frequency, a difference is set between a phase angle of a determined first test measurement signal and a phase angle of a second test measurement signal.

64. A method for commissioning, checking and/or testing a vibronic measuring system, the method comprising:
providing the test arrangement of claim 51;
checking the base module and/or the measuring system electronics using the test module of at least one measured value determined by the measuring system electronics with an associated reference value and/or at least one threshold value predetermined therefor;
removing the test module from the base module; and
inserting a vibronic module into the base module to form the vibronic measurement system,
wherein the measuring system comprises the base module and the vibronic module,
wherein at least one of:
the base module is configured to receive the vibronic module when the test module is not installed into the base module;
the base module is configured to receive the test module when the vibronic module is not installed into the base module;
the vibronic module and the base module are configured to be assembled without tools; and
the test module and the base module are configured to be assembled without tools, and
wherein the base module is configured to separately receive the vibronic module and the test module and to be connected thereto in a mechanically fixed yet detachable manner and/or such that the vibronic module and test module are each immovable or are locked in the base module.

65. The method according to claim 62, wherein providing the test arrangement further comprises inserting the test module into the base module after removing the vibronic module from the base module.
